(19) United States
(12) Patent Application Publication
(10) Pub. No.: US 2002/0188770 A1
(43) Pub. Date: Dec. 12, 2002

(54) Method and apparatus for selecting an optimal capability between a computer system and a peripheral device

(75) Inventor: David C. Kehlet, Los Altos, CA (US)

Correspondence Address: B. Noel Kivlin, Conley, Rose, & Tayon, P.C., P.O. Box 398, Austin, TX, 78767, US

(73) Assignee: Sun Microsystems, Inc.

(21) Appl. No.: 10/218,350

(22) Filed: Aug. 14, 2002

Related U.S. Application Data
(63) Continuation of application No. 08/648,257, filed on May 13, 1996, now abandoned.

(51) Int. Cl. G06F 13/14

(52) U.S. Cl. 710/8

(57) ABSTRACT

A host computer system selects optimal matching capabilities supported by both the host computer system and a peripheral device coupled to the computer system. Capabilities include video display device capabilities such as the display resolution. In one embodiment, upon detecting a triggering event such as a power-up, the computer system sends a request for a preferred range of capabilities supported by said peripheral device using a predetermined protocol. If the device is capable of communicating using the predetermined protocol, the device responds by sending its preferred range of capabilities. Next, the host computer compares the preferred range of capabilities with a corresponding range of capabilities supported by said computer system, and attempts to select an optimal matching capability between the preferred range of capabilities and the corresponding range of capabilities. In this example, if there is an optimal match, the computer system begins to provide a video signal using the optimal resolution. Otherwise, the computer system will provide a video signal using a default resolution.

### BACKGROUND OF THE INVENTION

1. Field of the Invention

This invention relates to the field of establishing compatible protocols. More particularly, the present invention relates to the field of selecting an optimal protocol compatible with the capability of a computer system peripheral.

2. Description of the Related Art

The proliferation of video display device technologies including CRTs and flat displays has resulted in an explosion of permutations of display capabilities, e.g., resolutions, refresh rates, brightness and contrast. The odds of randomly coupling a computer system to a video display device of unknown capability and expecting the entire system to work optimally are slim.

In one basic conventional scheme, a computer system may select a predetermined capability supported by most display devices and attempts to drive the video display using the default capability, e.g., at a resolution of 640×480 pixels. Unfortunately, in such a basic scheme there is no way for the computer system to know if the default resolution is supported by the video display device since there is no way for the display device to communicate any information back to the computer system, i.e., to cause the computer system to select another resolution.

FIG. 1 illustrates one slightly improved scheme in which a computer system 110 receives a static digital code, e.g., a 3 or 4 bit binary code, representing a supported resolution from a video display device 190. The static binary code transmitted via static digital lines 170 enables system 110 to select the supported resolution thereby ensuring compatibility. Subsequently, computer system 110 transmits an analog video signal to device 190 via analog line 180.

Unfortunately, there are two major problems with this inflexible technique. First, only one digital code can communicate to computer system 110. Second, the manufacturers of computer system 110 and device 190 have to agree on a standard encoding scheme for a predetermined range of resolutions. As video displays evolve and higher resolutions become commercially feasible, there is no easy way to change the encoding schemes of the existing computer systems and/or display devices to accommodate new code for new resolutions.

In a more sophisticated scheme, static digital lines 170 which couple computer system 110 to device 190 may be replaced by a bi-directional communication channel for exchanging information between computer system 110 and device 190. Communication channel may be based on a suitable protocol such as RS-232. In his example, when computer system 110 and video display device 190 are powered up, device 190 is able to send a list of device capabilities including resolution(s) supported by device 190, to computer system 110 via the bi-directional communication channel. However, even with the knowledge of resolution(s) supported by device 190, system 110 is still unable to figure out if the resolution is optimal for the combination of system 110 and monitor 190.

Hence, there is a need for a method and apparatus for establishing selecting an optimal capability, such as an optimal display resolution, between a computer system and a peripheral device.

### SUMMARY OF THE INVENTION

The present invention provides a host computer system for selecting optimal matching capabilities supported by both the host computer system and a peripheral device coupled to the computer system. Capabilities include video display device capabilities such as the display resolution.

In one embodiment, upon detecting a triggering event such as a power-up, the computer system sends a request for a preferred range of capabilities supported by said peripheral device using a predetermined protocol. An exemplary preferred range of capabilities is a list of capabilities supported by the peripheral device that includes a priority ordering from the most preferred capability to the least preferred capability. If the device is capable of communicating using the predetermined protocol, the device responds by sending its preferred range of capabilities.

Next, the host computer compares the preferred range of capabilities with a corresponding range of capabilities supported by said computer system, and attempts to select an optimal matching capability between the device's preferred range of capabilities and the computer system's corresponding range of capabilities. An optimal match is made when there is at least one common capability between the device and the computer system, and the computer system selects the common capability that has the highest preference.

In this example, if there is an optimal match, the computer system begins to provide a video signal using the optimal resolution. Otherwise, the computer system will provide a video signal using a default resolution.

### DESCRIPTION OF THE DRAWINGS

The objects, features and advantages of the system of the present invention will be apparent from the following description in which:

FIG. 1 illustrates a conventional scheme for translating a video display resolution between a video display device and a host computer system.

FIG. 2 is a block diagram illustrating an exemplary scheme for selecting an optimal capability between a host computer system and a video display device in accordance with the present invention.

FIG. 3A and 3B are flowcharts illustrating the exemplary selection scheme used by the host computer system of FIG. 2.

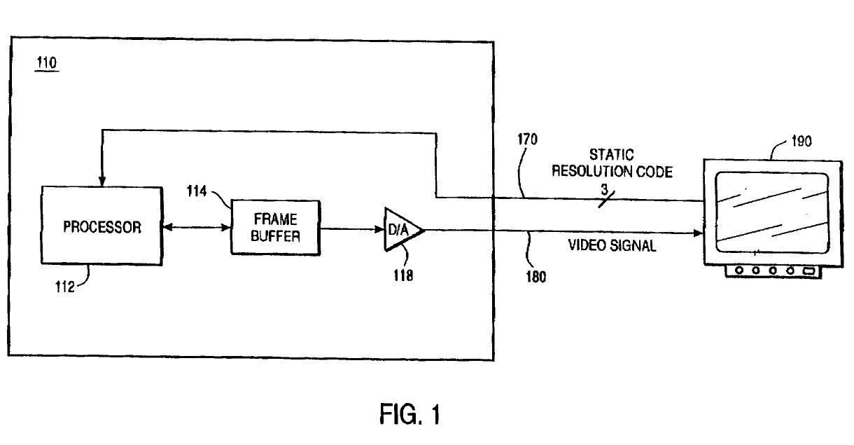

### DESCRIPTION OF THE PREFERRED EMBODIMENTS

In the following description, numerous details provide a thorough understanding of the invention. These details include functional blocks and an exemplary communication protocol to assist a designer in implementing an optimal capability selection scheme. In addition, while the present invention is described with reference to the selection of a specific capability, ie., a display resolution for a video display device, the invention is applicable to a wide range of peripheral device capabilities, e.g., R/F frequency, refresh rate and blank interval code. In other instances, well-known circuits and structures are not described in detail so as not to obscure the invention unnecessarily.

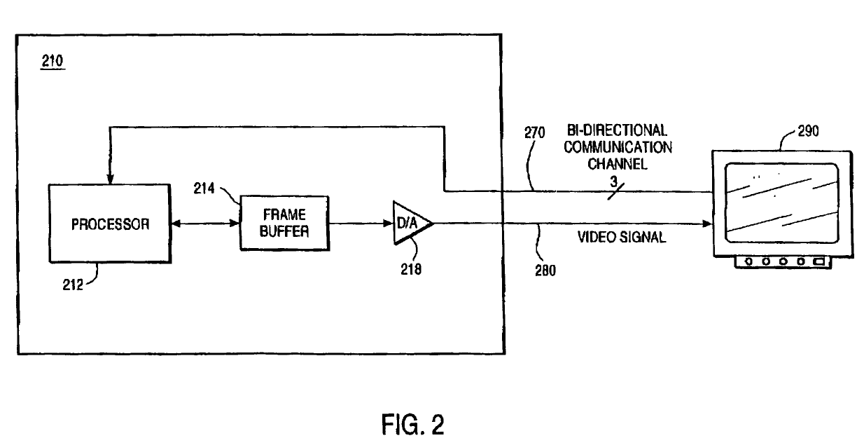

FIG. 2 is, a block diagram illustrating an exemplary scheme for selecting an optimal capability between a host computer system 210 and a video display device 290 in accordance with the present invention. Computer system 210 includes a processor 212 and a frame buffer 214. System 210 is coupled to video display device 290 via a video line 280 and a bi-directional communication channel 270. In this embodiment, the underlying bi-directional communication protocol used on channel 270 is the DDC2B (Display Data Channel) protocol promulgated by the Video Electronic Standard Association. Appendix A is a detailed description of the DDC family of protocols.

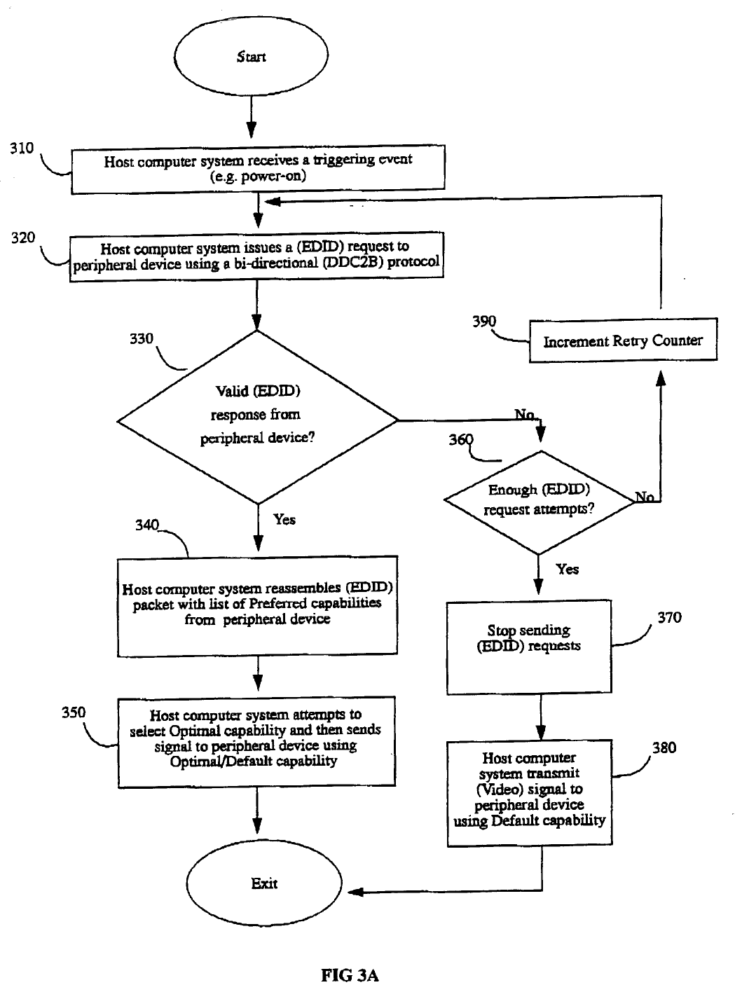

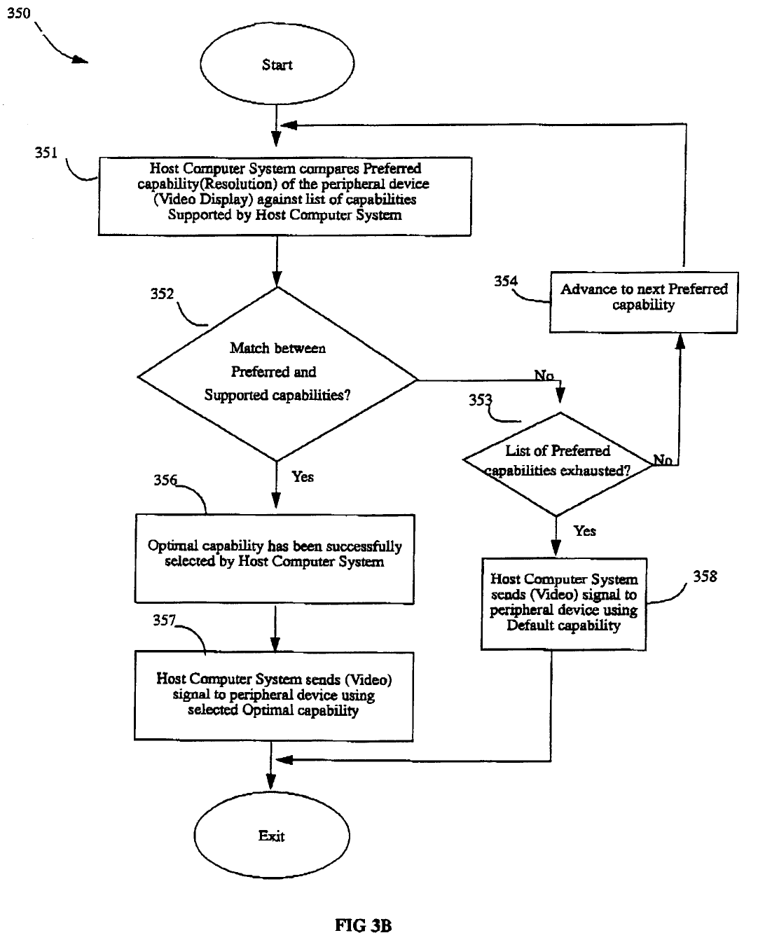

Referring now to the flowchart of FIG. 3A, when host computer system 210 receives a triggering event (step 310), e.g., when system 210 is powered-up, system 210 issues an Extended Display Identification Data (EDID) request using the DCC2B protocol (step 320). In this example, system 210 is also responsible for resetting a retry counter.

If a valid DCC2B response, i.e., a valid EDID packet, is received from display device 290 (step 330), system 210 attempts to reassemble the EDID packet (step 340). In this implementation, a valid EDID packet includes a preferred capability list comprising two or more display capability arranged in a descending order of preference. Upon a successful reassembly of the EDID packet, system 210 selects an optimal capability, e.g., an optimal video display resolution (step 350). The optimal capability selection step 350 is described in greater detail below.

An exemplary list of preferred capabilities, e.g., video display resolutions, is shown as follows:

1280×1024 (@ 76 Hz)

1152×900 (@ 76 Hz)

1024×768 (@ 60 Hz)

1920×1080 (@ 72 Hz)

640×480 (@ 60 Hz)

Note that the order of display resolutions within a list is not necessarily arranged in a numerically ascending nor descending order. In this example, the preference of a display resolution is implicit by the resolution's order in the list, i.e., the first resolution has the greatest preference, the second resolution has the next highest preference, and the last resolution has the lowest preference. Note further that there are alternative ways of representing preferences, i.e. priorities, within a preferred list of capabilities. For example, display device 290 may provide system 210 with a list which includes relative or absolute weights for each display resolution.

Referring again to FIG. 3A, conversely, if there is no response from device 290 or an invalid response is received from device 290 (step 330), then system 210 checks the retry counter to determine if system 210 has attempted a predetermined number of retries (step 360). If the number of reties has not reached the predetermined number of mandatory reties, then the retry counter is incremented (step 390).

On the other hand, if the system 210 has attempted the mandatory number of retries without success, then system 210 concludes that communication protocol(s) supported by device 290 on communication channel 270 is incompatible with the DCC2B protocol. Accordingly, communications between system 210 and device 290 is terminated (step 370). System 210 then transmits a video signal to device 290 via video line 280 using a best guess of a possibly compatible resolution, generally a commonly used default resolution (step 380).

The flowchart of FIG. 3B is a decomposition of step 350 for selecting an optimal resolution for the combination of system 210 and device 290. Beginning at the top of the preferred list of capabilities, processor 212 compares a resolution from the preferred list against the list of resolutions supported by system 210 (step 351). If there is no match between the preferred resolution and the resolutions supported by system 210 (step 352), and the list of preferred resolutions has not been exhausted (step 353), system 210 advances to the next preferred resolution remaining on the preferred list (step 354). Comparison step 351 is then repeated.

However, if there is no match between the preferred resolution and the resolutions supported by system 210 (step 352), and the list of preferred resolutions has been exhausted (step 353), then system 210 attempts to provide device 290 with a video signal via video line 280 using a default resolution (step 358).

Conversely, if there is a match between the preferred resolution and one of the resolutions supported by system 210, an optimal resolution has been successfully selected by system 210 (step 356). Subsequently, system 210 is able to provide device 290 with a video signal via video line 280 at the selected optimal resolution (step 357).

While the present invention has been described with reference to specific embodiments, numerous additions and modifications are possible without departing from the spirit of the invention. For example, the preferred capability to be optimized may be a refresh rate, an MPEG level of encoding or an image ratio. Hence, the scope of the invention should be determined by the following claims.

What is claimed is:

1. A method for matching capabilities supported both by a computer system and a peripheral device coupled to said computer system, said method comprising the steps of:
detecting a triggering event;
sending a request for a preferred range of capabilities supported by said peripheral device to said device;
receiving said preferred range of capabilities at said computer system;
comparing said preferred range of capabilities with a corresponding range of capabilities supported by said computer system; and
selecting an optimal matching capability between said preferred range of capabilities and said corresponding range of capabilities.

2. The method of claim 1 wherein said preferred range of capabilities is arranged in a preferred order.

3. The method of claim 2 wherein said peripheral device is a video display device, said preferred range of capabilities is received at said computer system using a DDC2B-based protocol, and said optimal matching capability is a video display resolution.

4. The method of claim 1 wherein each said preferred capability is associated with a relative or absolute weight.

5. A processor configured to match capabilities supported both by a computer system and a peripheral device coupled to said computer system, said selector comprising:
a trigger configured to detect a triggering event;
a transmitter configured to send a request for a preferred range of capabilities supported by said peripheral device;
a receiver configured to receive said preferred range of capabilities at said computer system; and
a comparator configured to compare said preferred range of capabilities with a corresponding range of capabilities supported by said computer system, and said comparator also configured to match an optimal capability between said preferred range of capabilities and said corresponding range of capabilities.

6. The processor of claim 5 wherein said preferred range of capabilities received by said receiver is arranged in a preferred order.

7. The processor of claim 6 wherein said peripheral device is a video display device, said preferred range of capabilities received by said receiver is in a DDC2B-based protocol, and said optimal matching capability is a video display resolution.

8. The processor of claim 5 wherein each said preferred capability received by said receiver is associated with a relative or absolute weight.
